(19) United States
(12) Patent Application Publication
(10) Pub. No.: US 2013/0255638 A1
(43) Pub. Date: Oct. 3, 2013

(54) GAS FUEL PRESSURE CONTROL DEVICE

(71) Applicant: DENSO CORPORATION, Kariya-city (JP)

(72) Inventors: Akira TAKAGI, Obu-city (JP); Haruhiko UNO, Okazaki-city (JP); Makoto KONDO, Nishikamo-gun (JP)

(73) Assignee: DENSO CORPORATION, Kariya-city (JP)

(21) Appl. No.: 13/850,541

(22) Filed: Mar. 26, 2013

(30) Foreign Application Priority Data
Mar. 27, 2012 (JP) 2012-71459

(51) Int. Cl. F02M 69/00

(52) U.S. Cl. CPC F02M 69/00
USPC 123/472

(57) ABSTRACT

A regulator is provided with a first pressure reducing valve, a second pressure reducing valve, and a load adjusting part. A gas fuel pressure in a fuel tank is reduced to 1.4 MPa from 20 MPa by the first pressure reducing valve, and then reduced to 0.2 to 0.65 MPa by the second pressure reducing valve. In the second pressure reducing valve, the pressure of the gas fuel is reduced to 0.2 to 0.65 MPa from 1.4 MPa, so that the resistive force of a second O-ring for sealing a first middle-pressure chamber and a second pressure chamber can be made smaller. A sliding resistance between a needle and the second O-ring is reduced. An electromagnetic attracting force generated by the load adjusting part can be made smaller. Electricity consumed by the load adjusting part can be reduced and the regulator can be made smaller.

### CROSS-REFERENCE TO RELATED APPLICATION

This application is based on Japanese Patent Application No. 2012-71459 filed on Mar. 27, 2012, the disclosure of which is incorporated herein by reference.

### TECHNICAL FIELD

The present disclosure relates to a gas fuel pressure control device for controlling pressure of a gas fuel to be supplied to an internal combustion engine.

### BACKGROUND

There has been known a gas fuel pressure control device for controlling the pressure of a gas fuel, which is to be supplied to an internal combustion engine using the gas fuel as fuel, for example, CNG (Compressed Natural Gas) from a high pressure in a fuel tank to a low pressure at which a gas fuel injector can inject the gas fuel.

European Patent No. 1748178 describes a pressure control device for controlling the position of a spool which makes the fuel tank communicate with the gas fuel injector or which shuts off the fuel tank from the gas fuel injector by an electromagnetic drive portion.

However, in the pressure control device described in above European Patent, a gap is defined between the spool and a sleeve of housing the spool and the gas fuel flows into a flow passage for supplying the gas fuel to the gas fuel injector from the gap and hence an amount of supply of the gas fuel cannot be controlled with a high degree of accuracy. Thus, the gap needs to be closed by a seal or the like. The seal for closing the gap needs to hold a pressure difference between the pressure in the fuel tank and the pressure at which the gas fuel injector can inject the gas fuel, so that the seal needs to have a large resistive force. In the case of moving the spool against the seal having the large resistive force, the pressure control device needs to be provided with an electromagnetic drive portion capable of generating a large load force for moving the spool. For this reason, the pressure control device is increased in size and is increased in the electricity consumed to generate the large load force.

### SUMMARY

It is an object of the present disclosure to provide a gas fuel pressure control device having a small size and capable of changing the pressure of a gas fuel by a small amount of electricity consumed.

According to the present disclosure, a gas fuel pressure control device is used for a gas fuel supply system for controlling pressure of a gas fuel stored in a fuel tank and for supplying the gas fuel to an internal combustion engine via an injector. The gas fuel pressure control device includes a first pressure control portion for reducing the pressure of the gas fuel in the fuel tank to a first pressure. The gas fuel pressure control device includes a second pressure control portion for reducing the pressure of the gas fuel reduced by the in the first pressure control means to a second pressure at which the injection means can inject the gas fuel and which is smaller than the first pressure. Further, the gas fuel pressure control device includes a pressure value changing portion which is provided in the second pressure control portion. The pressure value changing portion can change a value of the second pressure to which the pressure of the gas fuel is reduced by the second pressure control portion.

The gas fuel pressure control device controls the pressure of the gas fuel in the fuel tank to a pressure, at which the gas fuel can be supplied to the internal combustion engine, in two steps. The first pressure control portion reduces to a first pressure of a provisional pressure between the pressure of the gas fuel in the fuel tank and the pressure at which the gas fuel can be supplied to the injector. The second pressure control portion provided with the pressure value changing portion reduces the gas fuel, which is reduced to the first pressure by the first pressure control portion, to the second pressure at which the gas fuel can be supplied to the injector. The value of the second pressure can be changed by the pressure value changing portion.

The gas fuel supplied to the second pressure control portion has the pressure adjusted to the first pressure by the first pressure control portion. Thus, a pressure difference between the first pressure and the second pressure to which the second pressure control portion needs to reduce is comparatively small. In this way, a force which the pressure value changing portion applies to the second pressure control portion can be made smaller. Thus, while the pressure control device is decreased in size and is reduced in electricity consumption, the pressure control device can change the pressure of the gas fuel supplied to the gas fuel injector.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram to show a general construction of a gas fuel supply system;

FIG. 2 is a section view of a first pressure reducing valve and a second pressure reducing valve provided in a gas fuel pressure control device;

FIG. 3 is a schematic diagram to illustrate a flow of a gas fuel and a change in pressure of the gas fuel in the gas fuel pressure control device; and

FIG. 4 is a characteristic graph to show a relationship between a command current transmitted to the second pressure reducing valve and the pressure of the gas fuel supplied by the second pressure reducing valve.

### DETAILED DESCRIPTION

Hereinafter, embodiments of a gas fuel pressure control device according to the present disclosure will be described on the basis of the drawings.

### First Embodiment

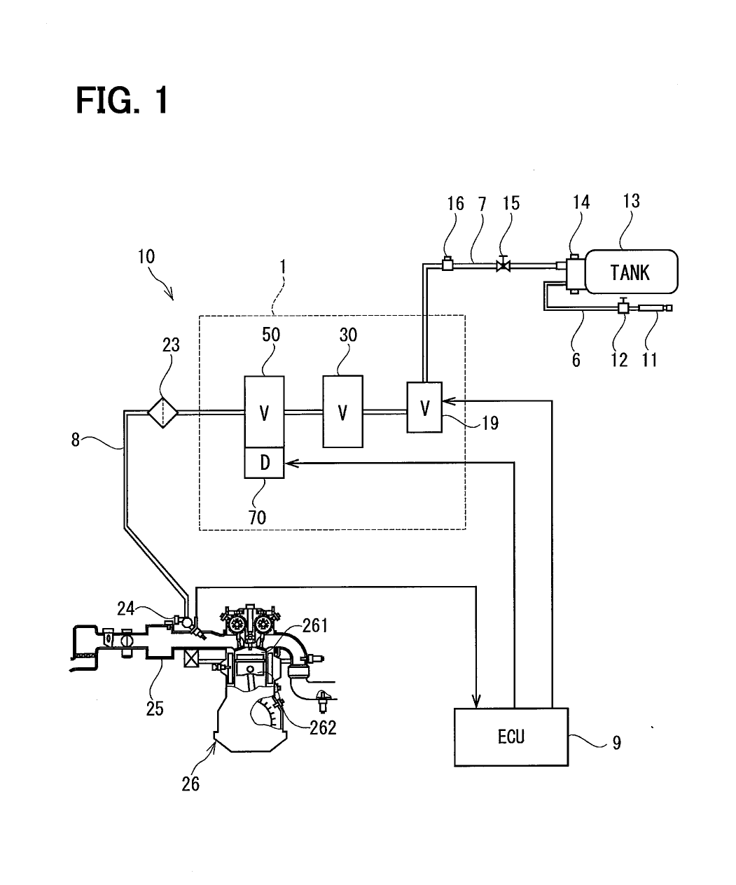

First, the general construction of a gas fuel supply system to which the present disclosure is applied will be described on the basis of FIG. 1. A gas fuel supply system 10 is mounted, for example, in a vehicle using compressed natural gas as fuel. The gas fuel supply system 10 is provided with a gas filling port 11, a fuel tank 13, a regulator 1 as “a gas fuel pressure control device”, a gas fuel injector 24 as an “injection portion”, and an ECU 9.

A high-pressure gas fuel supplied from outside through the gas filling port 11 is passed through a supply pipe 6 and is stored in the fuel tank 13. The gas filling port 11 has a back-flow prevention function to prevent the gas fuel supplied from the gas filling port 11 from flowing back to the outside. The supply pipe 6 is provided with a gas filling valve 12.

The fuel tank 13 is provided with a fuel tank valve 14. The fuel tank valve 14 has a back-flow prevention function of preventing from flowing back to the gas filling port 11 from the fuel tank 13. The fuel tank valve 14 has an excess-flow prevention function of intercepting the flow of the gas fuel from the fuel tank 13 when the gas fuel of a specified amount or more flows through a connection pipe 7. Further, the fuel tank valve 14 has a pressurization prevention safety function of opening pressure in the fuel tank 13 to the outside when the pressure in the fuel tank 13 is increased to thereby prevent the fuel tank 13 from being broken.

The fuel tank valve 14 is connected to the regulator 1 via the connection pipe 7. The connection pipe 7 is provided with a master valve 15 capable of manually shutting off the connection pipe 7 and a main stop valve 16 capable of electrically shutting off the connection pipe 7.

The regulator 1 is constructed of an electromagnetic shutoff valve 19, a first pressure reducing valve 30, a second pressure reducing valve 50, and an electromagnetic drive part 70. The regulator 1 reduces the pressure of the gas fuel supplied through the connection pipe 7 to a pressure that can be supplied to the gas fuel injector 24. For example, the regulator 1 reduces the gas fuel having a pressure of 20 MPa in the fuel tank 13 to a pressure of 0.2 to 0.65 MPA of the pressure that can be supplied to the gas fuel injector 24. The regulator 1 can change the pressure of the gas fuel supplied to the gas fuel injector 24 within a desired range. The detailed structures of the first pressure reducing valve 30 and the second pressure reducing valve 50 of the regulator 1 will be described later.

The gas fuel having pressure reduced by the regulator 1 has oil removed by an oil filter 23 and is supplied to the gas fuel injector 24 through the supply pipe 8. The gas fuel injector 24 injects the gas fuel into an intake pipe 25 according to an instruction of the ECU 9 to which the gas fuel injector 24 is electrically connected. The gas fuel injector 24 is provided with a temperature sensor and a pressure sensor which are not shown in the drawing. Information relating to the temperature and the pressure of the gas fuel detected by the temperature sensor and the pressure sensor is transmitted to the ECU 9. The ECU 9 determines the pressure of the gas fuel that the second pressure reducing valve 50 supplies on the basis of the information relating to the gas fuel and the information relating to the travel of a vehicle. Further, the ECU 9 transmits the determined pressure to the electromagnetic drive part 70 which can change the pressure of the gas fuel that the second pressure reducing valve 50 supplies.

The gas fuel injected into the intake pipe 25 is mixed with air introduced from the atmosphere and is introduced into a cylinder 261 from an intake port of an engine 26 to which the intake pipe 25 is connected. In the engine 26, a rotational torque is generated by the compression and explosion of a mixed gas of the gas fuel and the air. The compression and explosion of the mixed gas is conducted when a piston 262 is moved up. In this way, the gas fuel supply system 10 reduces the high-pressure gas fuel to a low pressure, which can be supplied to the gas fuel injector 24, by the regulator 1 to supply the low-pressure gas fuel to the engine 26 by means of the gas fuel injector 24.

In the description of the present embodiment, as a matter of convenience, the magnitude of the pressure of the gas fuel is called “high pressure”, “low pressure”, and “middle pressure”. The “high pressure” is the pressure of the gas fuel filled in the fuel tank 13 and indicates, for example, a pressure of 20 MPa. Further, the “low pressure” is the pressure of the gas fuel which is supplied to the gas fuel injector 24 by the regulator 1 and which can be supplied to the gas fuel injector 24 and indicates, for example, a pressure of 0.2 to 0.65 MPa. Still further, the “middle pressure” is the pressure of the gas fuel flowing between the first pressure reducing valve 30 and the second pressure reducing valve 50 and indicates, for example, a pressure of about 1.4 MPa as will be described later. The “middle pressure” corresponds to a “first pressure” and the “low pressure” corresponds to a “second pressure”.

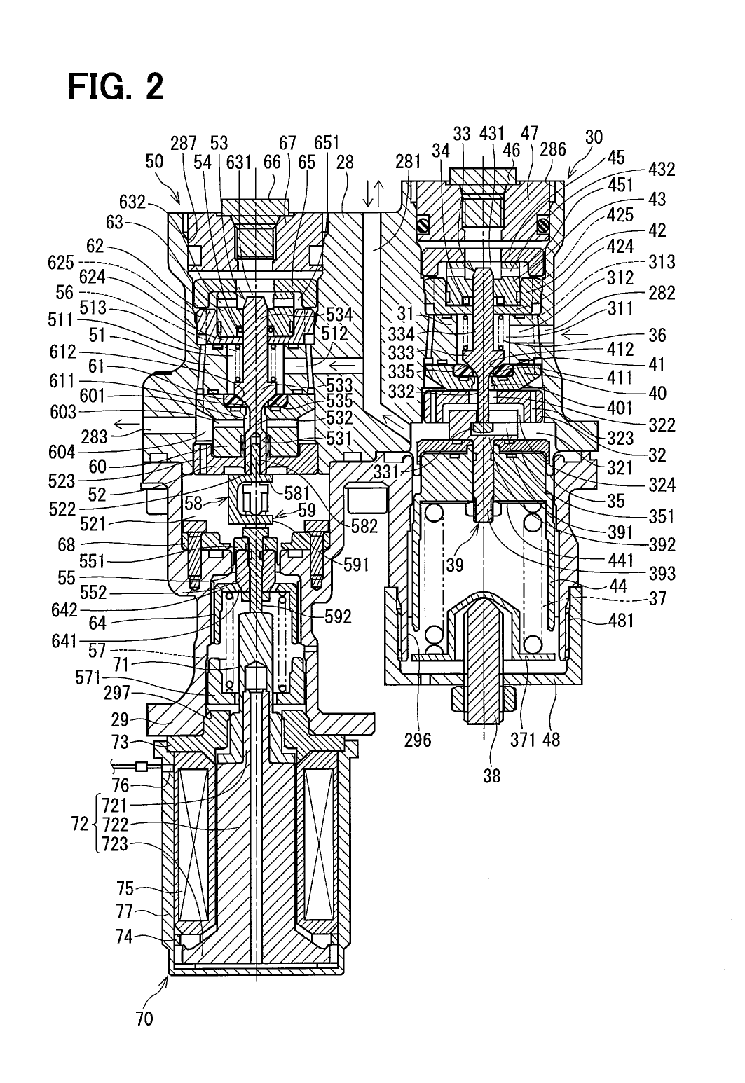

Next, the detailed structures of the first pressure reducing valve 30 as a “first pressure control portion” and the second pressure reducing valve 50 as a “second pressure control portion”, both of which are provided in the regulator 1, will be described on the basis of FIG. 2. It should be noted that arrows in FIG. 2 shows a direction in which a liquid fuel flows.

The first pressure reducing valve 30 and the second pressure reducing valve 50 are so-called poppet type valves and are constructed of a plurality of parts housed in a first valve body 28 and a second valve body 29. In FIG. 2, an upper direction is referred to as “upper”, a lower direction is referred to as “lower”, a right-hand direction is referred to as “right”, and a left-hand direction is referred to as “left”. The first valve body 28 corresponds to “a first main valve body” and a “second main valve body”. The second valve body 29 corresponds to the “second main valve body”.

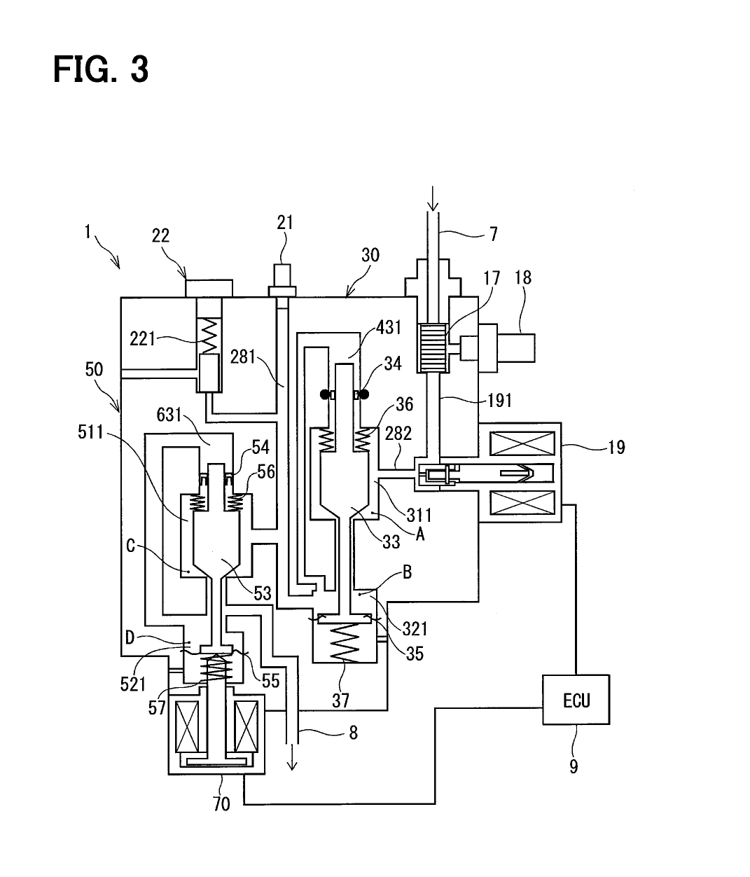

The first valve body 28 is a metal member provided in an upper portion in FIG. 2. Housing chambers 286, 287 are defined inn the first valve body 28. The housing chambers 286, 287 accommodate a plurality of parts of the first pressure reducing valve 30 and the second pressure reducing valve 50, respectively. The housing chambers 286, 287 are defined through the first valve body 28 in an up-and-down direction. Further, the housing chamber 286 communicates with the housing chamber 287 through a connection passage 281 defined in the first valve body 28. The connection passage 281 has a communication port in an upper portion in FIG. 2 and this communication port connects with a pressure switch 21 and a relief valve 22 (see FIG. 3). The connection passage 281 corresponds to a “first communication passage” and a “second communication passage”.

On the right-hand side of the first valve body 28, a flow passage 282 is defined so that the housing chamber 286 communicates with the outside of the first valve body 28. The flow passage 282 connects with the electromagnetic valve 19 (see FIG. 1). Further, on the left-hand side of the first valve body 28, a flow passage 283 is defined so that the housing chamber 287 communicates with the outside of the first valve body 28. The flow passage 283 connects with the supply pipe 8 (see FIG. 1) connecting with the gas fuel injector 24. The flow passage 282 corresponds to a “supply passage”. The flow passage 283 corresponds to a “discharge passage”.

The second valve body 29 is a metal member provided on the lower side of the first valve body 28. In the second valve body 29, housing chambers 296, 297 which house a plurality of parts of the first pressure reducing valve 30 and the second pressure reducing valve 50 are respectively defined. The housing chambers 296, 297 are defined through the second valve body 29 in the up-and-down direction. The first valve body 28 is combined with the second valve body 29 to define a space for housing the parts that construct the first pressure reducing valve 30 and the second pressure reducing valve 50, respectively.

Next, the construction of the first pressure reducing valve 30 will be described on the basis of FIG. 2.

The first pressure reducing valve 30 is provided with: a high-pressure-chamber forming part 31 for forming a high-pressure chamber 311; a middle-pressure chamber forming part 32 for forming a middle-pressure chamber 321; a needle 33 reciprocating in the high-pressure chamber 311 and a middle-pressure chamber 321; a first O-ring 34; a first diaphragm 35; a first valve-closing-side spring 36; a first valve-opening-side spring 37; and a spring load adjusting screw 38.

The high-pressure-chamber forming part 31 is a hollow cylindrical metal part and is disposed nearly in the center of the housing chamber 286. In the high-pressure-chamber forming part 31, a communication passage 312 is defined so as to communicate with the high-pressure chamber 311 in a horizontal direction. The communication passage 312 communicates the flow passage 282 and the high-pressure chamber 311. The outside diameter of the high-pressure-chamber forming part 31 is smaller than the inside diameter of the housing chamber 286 in which the high-pressure-chamber forming part 31 is defined. An annular flow passage 313 is defined between an inner wall of the housing chamber 286 and an outer wall of the high-pressure-chamber forming part 31. In the high-pressure chamber 311 is housed a portion of the needle 33.

The needle 33 is comprised of: an engaging portion 331 formed on the lowest side; a small-diameter portion 332 extended upward from the engaging portion 331; a valve portion 333 connecting with the upper side of the small-diameter portion 332; and a large-diameter portion 334 connecting with the upper side of the valve portion 333. The needle 33 corresponds to a “first valve part”.

The engaging portion 331 is formed nearly in the shape of a circular disk having an outside diameter larger than the small-diameter portion 332 and is engaged with a coupling part 36 which will be described later. A face on the coupling part 39 side of the engaging portion 331 is worked in a spherical shape in such a way as to be in point contact with the inner wall of the coupling part 39.

The small-diameter portion 332 passes through a through-hole 322 of the first middle-pressure chamber forming part 32, a through-hole 401 of a valve seat holder 40, and a through hold 411 of a first valve seat 41 in such a manner as to connect the engaging portion 331 with the valve portion 333.

The valve portion 333 is formed in a shape tapered downward in FIG. 2. In the valve portion 333, a tapered face 335 is formed in such a way as to abut on a second seat face 412 of the second valve seat 41. An upper end portion of the valve portion 333 has the large-diameter portion 334 connected therewith and has a seat portion formed thereon. The seat portion has an end of the first valve-closing-side spring 36 engaged therewith.

The large-diameter portion 334 passes through a through-hole defined in the center of a spring engaging part 42 and protrudes into a first pressure chamber 431. A projection area in an axial direction of an end portion of the large-diameter portion 334 protruding into the first pressure chamber 431 is defined to be equal to a projection area in the axial direction of an exposed face on the first middle-pressure chamber 321 side of the tapered face 335 radially inside a portion in which the tapered face 335 abuts on the first seat face 412.

The spring engaging part 42 is formed of a metal part formed in the shape of a cylinder having a closed end. The spring engaging part 42 has an end of the first valve-closing-side spring 36 engaged with the lower side of a bottom wall 424 thereof. The spring engaging part 42 has the first O-ring 34 disposed on the upper side of the bottom wall 424 thereof. Further, the outside diameter of the bottom wall 424 is smaller than the inside diameter of the housing chamber 286 in which the spring engaging part 42 is disposed. An annular flow passage 425 communicating with the annular flow passage 313 is defined between the bottom wall 424 of the spring engaging part 42 and the inner wall of the housing chamber 286. The annular flow passage 425 communicates with an annular space 451, which is defined above the spring engaging part 42 via a cutout defined in a side wall of a cylindrical portion of the spring engaging part 42.

The first valve-closing-side spring 36 biases the needle 33 in a direction in which the tapered face 335 abuts on the first seat face 412. The biasing force of the first valve-closing-side spring 36 is smaller than the biasing force of a first valve-opening-side spring 37 which will be described later. The first valve-closing-side spring 36 prevents the needle 33 from excessively moving in the upper direction of FIG. 2.

The first O-ring 34 is supported in such a way as to be sandwiched between the spring engaging part 42 and the first pressure-chamber forming part 43. The first O-ring 34 abuts on the outer wall of the large-diameter portion 334 of the needle 33 to seal between the high-pressure chamber 311 and the first pressure chamber 431 defined by the first pressure-chamber forming part 43. The O-ring 34 corresponds to a “first seal part”.

The first pressure-chamber forming part 43 has a portion housed in a depressed portion defined in the spring engaging part 42 and supports the large-diameter portion 334 of the needle 33 in such a way that the large-diameter portion 334 can slide. The first pressure-chamber forming part 43 has the first pressure chamber 431 defined in an upper portion thereof and has a communication passage 432 defined therein outward in a radial direction from the first pressure chamber 431. The communication passage 432 communicates with an annular space 451. The first pressure-chamber forming part 43 corresponds to the “first main valve body”.

A cylindrical part 45 is disposed on the upper side of the first pressure-chamber forming part 43. The cylinder part 45 is fastened to the inner wall of the housing chamber 286, for example, by screw fitting. The cylinder part 45 fixes the spring engaging part 42 and the first pressure-chamber forming part 43 in specified positions.

Above the cylinder part 45, a first cap 46 which is formed in the shape of a circular cylinder and a second cap 47 which houses the first cap 46 and is formed in the shape of a hollow cylinder are disposed. The first cap 46 and the second cap 47 close an opening defined in the upper portion of the housing chamber 286.

The first valve seat 41 is made of, for example, a polyimide resin nearly in the shape of a circular ring. In the center of the first valve seat 41, the through-hole 411 is defined. The small-diameter portion 332 of the needle 33 is passed through the through-hole. The first seat face 412 formed on the high-pressure chamber 311 side of the first valve seat 41 abuts on or separates from the tapered face 335 of the valve portion 333 when the needle 33 reciprocates in the up-and-down direction. In this way, the high-pressure chamber 311 shuts off from or communicates with the first middle-pressure chamber 321. The first valve seat 41 is supported by the valve seat holder 40.

The valve seat holder 40 is a hollow cylindrical part having an outer wall formed in a downward tapered shape. The valve seat holder 40 has a depressed portion in an upper portion thereof. The depressed portion houses the valve seat 41. Further, the valve seat holder 40 has a cutout defined in an outer peripheral portion thereof. The annular passage 313 communicates with the annular passage 323 of the first middle-pressure chamber forming part 32 via the cutout.

The first middle-pressure chamber forming part 32 is disposed on the lower end of the housing chamber 286. The first middle-pressure chamber forming part 32 is formed of a metal member in the shape of a cylinder having a closed bottom end. Nearly in the center of the first middle-pressure chamber forming part 32, a depressed portion 324 is defined so as to communicate with the through-hole 322. The depressed portion 324 has a portion of the coupling part 39 housed therein. Further, the annular passage 323 defined in the outer peripheral portion of the first middle-pressure chamber forming part 32 passes in the up-and-down direction. The first middle-pressure chamber 321 defined below the first middle-pressure chamber forming part 32 communicates with the cutout of the valve seat holder 40.

The coupling part 39 is a metal part having a section formed in the shape of a letter “T”. In a coupling portion 392 formed in an upper portion of the coupling part 39, a depressed portion 391 is defined. The engaging portion 331 of the needle 33 is engaged with the depressed portion 391. Further, the circular cylinder portion 393 formed in the lower portion of the coupling part 39 is fixed to a spring holder 44. The coupling part 39 corresponds to the “first valve part”.

The first diaphragm 35 is a diaphragm having a central portion supported from above by a diaphragm cover 351 and from below by the spring holder 44 in such a way as to be sandwiched between the diaphragm cover 351 and the spring holder 44. Both ends of the first diaphragm 35 are fixed to the lower end of the first valve body 28. The first diaphragm 35 seals the first middle-pressure chamber 321 and the housing chamber 296.

A spring holder 44 is a metal part disposed on an upper end of the housing chamber 296 and formed in the shape of a cylinder having a closed end. An end of the first valve-opening-side spring 37 is engaged with an inner bottom wall 441 of the spring holder 44. The circular cylinder portion 393 of the coupling part 39 protrudes downward from the inner bottom wall 441 via a through-hole. A lower end of the circular cylinder portion 393 is fixed to the inner bottom wall 441. The coupling part 39 is moved integrally with a movement in the up-and-down direction of the spring holder 44.

The first valve-opening-side spring 37 is a coil spring for applying a load to the spring holder 44 in an upper direction in FIG. 2, that is, in a direction in which the tapered face 335 of the valve portion 333 is separated from the first seat face 412 of the first valve seat 41. The other end of the first valve-opening-side spring 37 is engaged with a spring engaging part 371. An end portion of a spring load adjusting screw 38 abuts on the center of the spring engaging part 371. The spring load adjusting screw 38 is rotatably supported by a holder 48 of closing an opening on the lower side of the housing chamber 296. The holder 48 is fixed to the second valve body 29 via a bearing 481. The spring load adjusting screw 38 adjusts the position of the spring engaging part 371. In this way, the set load of the first valve-opening-side spring 37 can be changed.

Next, the configuration of the second pressure reducing valve 50 will be described on the basis of FIG. 2.

The second pressure reducing valve 50 is provided with: a second middle-pressure chamber forming part 51 for forming a second middle-pressure chamber 511; a low-pressure chamber forming part 52 for forming a low-pressure chamber 521; a needle 53 reciprocating in the second middle-pressure chamber 511 and the low-pressure chamber 521; a second O-ring 54; a second diaphragm 55; a second valve-closing-side spring 56; and a second valve-opening-side spring 57.

The second middle-pressure chamber forming part 51 is a hollow cylindrical metal part and is disposed nearly in the center of the housing chamber 287. The second middle-pressure chamber forming part 51 defines a communication passage 512 communicating with the second middle-pressure chamber 511 in the horizontal direction. The communication passage 512 connects the connection passage 281 and the second middle-pressure chamber 511. The outside diameter of the second middle-pressure chamber forming part 31 is smaller than the inside diameter of the housing chamber 287 in which the second middle-pressure chamber forming part 51 is formed. An annular flow passage 513 is defined between an inner wall of the housing chamber 287 and an outer wall of the second middle-pressure chamber forming part 51. In the second-pressure chamber 511 is housed a portion of the needle 53.

The needle 53 is includes: a coupling portion 531 formed on the lowest side; a small-diameter portion 532 extended upward from the coupling portion 531; a valve portion 533 connecting with the upper side of the small-diameter portion 532; and a large-diameter portion 534 connecting with the upper side of the valve portion 533. The needle 53 corresponds to the “second valve part”.

The coupling portion 531 is formed nearly in the shape of a letter “Y” and is coupled to a first coupling part 58 which will be described later.

The small-diameter portion 532 passes through a through-hole 601 of a valve seat holder 60 and a through-hole 611 of a second valve seat 61, so that the coupling portion 531 connects with the valve portion 533.

The valve portion 533 is formed in a shape tapered downward in FIG. 2. In the valve portion 533, a tapered face 535 is formed in such a way as to abut on a second seat face 612 of the second valve seat 61. An upper end portion of the valve portion 533 has the large-diameter portion 534 connected therewith and has a seat portion formed thereon. The seat portion has an end of the second valve-closing-side spring 56 engaged therewith.

The large-diameter portion 534 passes through a through-hole defined in the center of a spring engaging part 62 and protrudes into a second pressure chamber 631. A projection area in an axial direction of an end portion of the large-diameter portion 534 protruding into the second pressure chamber 631 is defined to be equal to a projection area in the axial direction of an exposed face on the low-pressure chamber 521 side of the tapered face 535 radially inside a portion in which the tapered face 535 abuts on the second seat face 612.

The spring engaging part 62 is formed of a metal part formed in the shape of a cylinder having a closed end. The spring engaging part 62 has an end of the second valve-closing-side spring 66 engaged with the lower side of a bottom wall 624 thereof. The spring engaging part 62 has the second O-ring 54 disposed on the upper side of the bottom wall 624 thereof. Further, the outside diameter of the bottom wall 624 is smaller than the inside diameter of the housing chamber 287 in which the spring engaging part 62 is disposed. An annular flow passage 625 communicating with the annular flow passage 513 is defined between the bottom wall 624 of the spring engaging part 62 and the inner wall of the housing chamber 287. The annular flow passage 625 communicates with an annular space 651 defined above the spring engaging part 62 via a cutout defined in a side wall of a cylindrical portion of the spring engaging part 62.

The second valve-closing-side spring 56 biases the needle 53 in a direction in which the tapered face 535 abuts on the second seat face 612. The biasing force of the second valve-closing-side spring 56 is smaller than the biasing force of a second valve-opening-side spring 57 which will be described later. The second valve-closing-side spring 56 prevents the needle 53 from moving upward in FIG. 2. It is prevented to separate a lower end of a circular cylinder portion 592 of the second coupling part 59 from an upper end of a needle 71.

The second O-ring 54 is supported in such a way as to be sandwiched between the spring engaging part 62 and the second-pressure chamber forming part 63. The second O-ring 54 as a “second seal part” abuts on the outer wall of the large-diameter portion 534 of the needle 53 to seal between the second middle-pressure chamber 511 and the second pressure chamber 631 defined by the second pressure-chamber-forming part 63.

A part of the second pressure-chamber-forming part 63 is accommodated in a depressed portion defined in the spring engaging part 62. The second pressure-chamber-forming part 63 supports the large-diameter portion 534 of the needle 53 in such a way that the needle 53 can slide. The second pressure-chamber-forming part 63 has the second pressure chamber 631 defined in an upper portion thereof. The second pressure-chamber-forming part 63 has a communication passage 632 which extends outward in a radial direction from the second pressure chamber 631. The communication passage 632 communicates with an annular space 651 defined between the second pressure-chamber-forming part 63 and a cylindrical part 65. The second pressure-chamber-forming part 63 corresponds to the “second main valve body”.

The cylindrical part 65 is disposed on the upper side of the second pressure-chamber-forming part 63. The cylinder part 65 is fastened to the inner wall of the housing chamber 287, for example, by screw fitting. The cylinder part 65 fixes the spring engaging part 62 and the second pressure-chamber-forming part 63 in specified positions.

A first cap 66 and a second cap 67 are disposed above the cylinder part 65. The first cap 66 is formed in a shape of a circular cylinder. The second cap is formed in the shape of a hollow cylinder to house the first cap 66. The first cap 66 and the second cap 67 close an opening defined in the upper portion of the housing chamber 287.

A second valve seat 61 is made of, for example, the polyimide resin nearly in the shape of a circular ring. A through-hole 611 is defined in the center of the second valve seat 61. The small-diameter portion 532 of the needle 53 is passed through the through-hole 611. The second seat face 612 formed on the second middle-pressure chamber 511 abuts on or separates from the tapered face 535 of the valve portion 533 when the needle 53 reciprocates in the up-and-down direction. In this way, the second middle-pressure chamber 511 shuts off from or communicates with the low-pressure chamber 521. The second valve seat 61 is supported by a valve seat holder 60.

The valve seat holder 60 is a metal part formed nearly in the shape of a circular cylinder. The valve seat holder 60 has a depressed portion for housing the second valve seat 61. The valve seat holder 60 has a through-hole 601 passing from the depressed portion to a lower portion of the valve seat holder 60. Further, the valve seat holder 60 has a communication passage 603 extending outward in the radial direction thereof from the through-hole 601. A coupling portion 531 of the needle 53, the small-diameter portion 532, and an upper end portion of the first coupling portion 591 are housed in the through-hole 601. Further, a lower portion of the valve seat holder 60 has a smaller outside diameter than an upper portion thereof. An annular space 604 is defined between an inner wall of the housing chamber 287 and an outer wall of the lower portion of the valve seat holder 60. The annular space 604 communicates with the flow passage 283 defined in the first valve body 28.

The low-pressure-chamber forming part 52 is disposed on a lower end of the housing chamber 287 and is formed in a shape of a cylinder having a closed end. A depressed portion communicating with the through-hole 522 is defined in the center of the low-pressure-chamber forming part 52. Further, a communication passage 523 defined in the outer peripheral portion of the low-pressure-chamber forming part 52 passes in the up-and-down direction. The low-pressure chamber 521 defined below the low-pressure-chamber forming part 52 communicates with the annular space 604.

The first coupling part 58 has a first coupling portion 581 of which cross section is shaped like a letter “C”. The first coupling part 58 has a circular cylinder portion 582 connecting with one end of the first coupling portion 581 formed in such a way as to be integrated with each other. The first coupling portion 581 is coupled to a second coupling portion 591 of the second coupling part 59. The circular cylinder portion 582 is fitted in a coupling portion 531 of the needle 53. The first coupling part 58 corresponds to a “second valve part”.

In the second coupling part 59, the second coupling portion 591 which is coupled to the first coupling portion 581 and the circular cylinder portion 592 which connects with the second coupling portion 591 are formed in such a way as to be integrated with each other. Each of an upper side and a lower side of the second coupling portion 591, which abut on the inner wall of a metal portion of the first coupling portion 581 which is formed in the shape of a letter “C”, is formed in a spherical face in such a way that the first coupling portion 581 is in point contact with the second coupling portion 591. In this way, in a case where the second coupling part 59 is moved not only in a vertical direction but also in a horizontal direction, only a movement in the vertical direction of the second coupling part 59 is transmitted to the first coupling part 58. The second coupling part 59 corresponds to the “second valve part”.

Further, a seat portion is formed in a position in which the second coupling portion 591 connects with the circular cylinder portion 592. An upper face of a diaphragm cover 551 abuts on the seat portion. Still further, in the center of the diaphragm cover 551, a through-hole is defined. The circular cylinder portion 592 is passed through the through-hole. A needle 71 of the electromagnetic drive part 70 abuts on a lower end of the circular cylinder portion 592 of the second coupling portion 591.

The second diaphragm 55 is a diaphragm having a central portion supported by a diaphragm cover 551 and a cylindrical part 552 in such a way as to be sandwiched between the diaphragm cover 551 and the cylindrical part 552. Both ends of the second diaphragm 55 as a “third seal part” are supported by the second valve body 29 and a diaphragm pressing part 68. The second diaphragm 55 seals the low-pressure chamber 521 and the housing chamber 297 communicating with the atmosphere.

A spring holder 64 is a metal part formed in the shape of a cylinder having a closed end. The spring holder 64 is journaled by an inner wall of the housing chamber 297. One end of the second valve-opening-side spring 57 is engaged with the inside of a bottom wall 642 of the spring holder 64. Further, a through-hole 641 is defined in the inner bottom wall 642. The circular cylinder portion 592 and the cylinder part 552 of the second coupling part 59 are passed through the through-hole 641. In this way, the spring holder 64 is moved up and down along with the second diaphragm 55, the diaphragm cover 551, the cylindrical part 552, and the second coupling part 59 according to the pressure of the gas fuel in the low-pressure chamber 521.

The second valve-opening-side spring 57 is a coil spring for applying a load to the spring holder 64 in an upper direction in FIG. 2, that is, in a direction in which the tapered face 535 of the valve portion 533 is separated from the second seat face 612 of the second valve seat 61. The other end of the second valve-opening-side spring 57 is engaged with a spring engaging part 571. The second valve-opening-side spring 57 corresponds to a “load applying portion”.

The spring engaging part 571 is fastened to an inner wall of the housing chamber 297 by screw fitting. By adjusting the position to the housing chamber 297 of the spring engaging part 571, the set load of the second valve-opening-side spring 57 can be changed. In the center of the spring engaging part 571, a through-hole is defined. The needle 71 of the electromagnetic drive part 70 is passed through the through-hole. The spring engaging part 571 corresponds to a “load adjusting portion”.

Next, the electromagnetic drive part 70 connecting with the second pressure reducing valve 50 will be described.

The electromagnetic drive part 70 is a linear solenoid which is constructed of a needle 71, a movable core 72, a first fixing part 73, a second fixed core 74, a coil 75, and a connector 76. The electromagnetic drive part 70 connects with an opening on the lower side of the housing chamber 297 and moves the needle 71 in the vertical direction to thereby change a pressure capable of opening the second pressure reducing valve 50. The electromagnetic drive part 70 corresponds to a “pressure value changing portion”.

One end of the needle 71 abuts on the circular cylinder portion 591 of the second coupling part 59. Further, in the other end of the needle 71, a press-fit portion 721 of the movable core 72 is press-fitted in and fixed to a fitting hole of the needle 71.

The movable core 72 is a magnetic material disposed in the axial direction of the electromagnetic drive part 70. The movable core 72 is comprised of the press-fit portion 721, a main body portion 722 connecting with the press-fit portion 721, and a large-diameter portion 723. The first fixing part 73 is provided on the outside in the radial direction of the press-fit portion 721 across the needle 71. Further, the main body portion 722 connects with the large-diameter portion 723 by a tapered side wall. The large-diameter portion 723 has a protrusion protruding in the upper direction formed on a peripheral edge portion thereof. The large-diameter portion 723 is journaled by the inner wall of a housing 77. The second fixed core 74 is provided on the outside in the radial direction of the large-diameter portion 723.

The first fixing part 73 is formed in a cylindrical shape in such a way as to be sandwiched between the second valve body 29 and the housing 77 of the electromagnetic drive part 70. A depressed portion is defined in the lower portion of the first fixing part 73. An upper end portion of the main body portion 722 can slide in the depressed portion. Further, a protrusion protruding in the lower direction is formed in the edge portion of the depressed portion.

The second fixed core 74 is formed in such a way as to extend along the inner wall of the housing 77 of the electromagnetic drive part 70. The inside diameter of the second fixed core 74 is larger than the outside diameter of an end portion opposite to the needle 71. The large-diameter portion 723 can slide in the fixing part 74.

The coil 75 is disposed on the outside in the radial direction of the main body portion 722. The coil 75 receives a command current supplied thereto from the ECU 9 via the connector 76 electrically connected to the coil 75. When the command current is supplied to the coil 75, a magnetic flux responsive to the command current is generated around the coil 75. In the magnetic flux, a magnetic path passes from the protrusion of the first fixing part 73 to the second fixed core 74 via an upper end portion of the main body portion 722 of the movable core 72, the main body portion 722, and the large-diameter portion 723. This generates a magnetic attracting force between the movable core 72 and the first fixing part 73 and the second fixed core 74. The needle 53 receives a load by the magnetic attracting force in a direction in which the tapered face 535 of the valve portion 533 is separated from the second seat face 612 of the second valve seat 61. At this time, the coil 75 is supplied with the current in a short cycle, so that the movable core 72 is vibrated little by little, whereby the load applied to the needle 53 by the electromagnetic drive part 70 is changed little by little.

Next, the flow of the gas fuel in the regulator 1 and a change in the pressure of the gas fuel will be described on the basis of FIG. 2 to FIG. 4 in combination with the actions of the first pressure reducing valve 30 and the second pressure reducing valve 50. In FIG. 3, in order to illustrate the pressure of the gas fuel in the regulator 1, regions in which the gas fuel exist are denoted by regions “A”, “B”, “C”, and “D”.

The gas fuel passes through the connection pipe 7 and flows into the regulator 1. Foreign matters in the gas fuel is removed by a gas filter 17 disposed on the most upstream of the regulator 1. Further, the pressure of the gas fuel in the flow passage is detected by a pressure sensor 18 disposed in the flow passage near the gas filter 17. Usually, the pressure of the gas fuel detected by the pressure sensor 18 is nearly equal to the pressure of the gas fuel in the fuel tank 13. In the present embodiment, the pressure of the gas fuel is 20 MPa.

The gas fuel which passed through the gas filter 17 passes through a passage 191 and a flow passage 282. The gas fuel flows into the high-pressure chamber 311 of the first pressure reducing valve 30. The electromagnetic shutoff valve 19 electrically connected to the ECU 9 is interposed between the passage 191 and the flow passage 282. The electromagnetic shutoff valve 19 shuts off a flow passage in the regulator 1 according to an instruction from the ECU 9. For example, when the vehicle is stopped, the gas fuel supplying to the first pressure reducing valve 30 is stopped.

The high-pressure gas fuel flowing into the high-pressure chamber 311 has pressure reduced to a middle pressure by the first pressure reducing valve 30. The action of the first pressure reducing valve 30 will be described. In the pressure reducing valve 30, the needle 33 has a load applied thereto in an upper direction in FIG. 2 by the first valve-opening-side spring 37 via the coupling part 39. Also, the needle 33 has a load applied thereto in a lower direction in FIG. 2 by the first valve-closing-side spring 36. In a case where the tapered face 335 of the valve portion 333 is separated from the first seat face 412 of the first valve seat 41, the gas fuel in the high-pressure chamber 311 passes through the through-hole 411 of the first valve seat 41, the through-hole 401 of the valve seat holder 40, the through-hole 322 of the first middle-pressure-chamber forming part 32, and the depressed portion 324. Then, the gas fuel flows into the first middle-pressure chamber 321.

The pressure of the gas fuel flowing into the first middle-pressure chamber 321 is applied to the upper face of the diaphragm cover 351 and the upper face of the first diaphragm 35, so that the diaphragm cover 351 and the spring holder 44 are moved in the lower direction in FIG. 2. The coupling part 39 fixed to the spring holder 44 and the needle 33 coupled to the coupling part 39 are also moved in the lower direction in FIG. 2, whereby the tapered face 335 abuts on the first seat face 412. In this way, the high-pressure chamber 311 is shut off from the first middle-pressure chamber 321.

At this time, as shown in FIG. 3, the pressure of the gas fuel in the region “A” of the high-pressure chamber 311 is, for example, a high pressure of 20 MPa. The pressure of the gas fuel in the region “B” of the first middle-pressure chamber 321 is reduced to, for example, a middle pressure as high as 1.4 MPa by the first pressure reducing valve 30. The pressure of the gas fuel in the region “B” can be changed by adjusting the spring load adjusting screw 38. For example, when the spring load adjusting screw 38 is screwed into the holder 48, the pressure of the gas fuel in the region “B” can be increased. When the spring load adjusting screw 38 is released for the holder 48, the pressure of the gas fuel in the region “B” can be decreased.

When the gas fuel in the first middle-pressure chamber 321 is moved to the second pressure reducing valve 50, the pressure of the gas fuel in the first middle-pressure chamber 321 is decreased. When the pressure of the gas fuel in the first middle-pressure chamber 321 is decreased, the pressure applied to the upper face of the diaphragm cover 351 and the upper face of the diaphragm 35 is decreased, so that the load by the first valve-opening-side spring 37 is applied to the needle 33. Thus, the tapered face 335 of the valve portion 333 is separated from the first seat face 412 of the first valve seat 41. In this way, the high-pressure chamber 311 communicates with the first middle-pressure chamber 321. The gas fuel flows into the first middle-pressure chamber 321 from the high-pressure chamber 311.

Further, the middle-pressure gas fuel flowing into the first middle-pressure chamber 321 passes through the annular flow passage 323 of the first middle-pressure-chamber forming part 32, the cutout of the valve seat holder 40, the annular flow passage 313 of the high-pressure-chamber forming part 31, the annular flow passage 425 of the spring engaging part 42, the annular space 451 of the cylindrical part 45, and the communication passage 432 of the first pressure-chamber forming part 43. Then, the middle-pressure gas flows into the first pressure chamber 431. In this way, the pressure of the gas fuel in the first middle-pressure chamber 321 is equal to the pressure of the gas fuel in the first pressure chamber 431. The end portion of the large-diameter portion 334 protruding into the first pressure chamber 431 is formed in such a way as to have an area equal to an area in which the tapered face 335 abuts on the first seat face 412. In this way, the load applied to the needle 33 by the pressure of the gas fuel in the high-pressure chamber 311 is cancelled.

The gas fuel in the first middle-pressure chamber 321 passes through a connection passage 281 and flows into the second middle-pressure chamber 511 of the second pressure reducing valve 50. The connection passage 281 is provided with a pressure switch 21 and a relief valve 22. The relief valve 22 is provided with a spring 221 for closing an opening of the connection passage 281 by a load corresponding to a given value. When the pressure of the gas fuel in the connection passage 281 becomes the given value or more, the relief valve 22 is opened. In this way, the relief valve 22 discharges the gas fuel to the outside to thereby prevent the regulator 1 from being damaged. When the pressure of the gas fuel in the connection passage 281 becomes high and the relief valve 22 is opened, the pressure switch 21 detects a damage of the regulator 1 and outputs a command for shutting off the passage 191 and the flow passage 282 to the electromagnetic shutoff valve 19.

The gas fuel flowing into the second middle-pressure chamber 511 has pressure reduced to a low pressure by the second pressure reducing valve 50. The action of the second pressure reducing valve 50 will be described. A load produced by the second valve-opening-side spring 57 via the first coupling part 58 and the second coupling part 59 and a load produced by the electromagnetic drive part 70 are applied independently to the needle 53 of the second pressure reducing valve 50 in the upper direction in FIG. 2. The pressure of the gas fuel supplied to the gas fuel injector 24 by the second pressure reducing valve 50 is calculated by the following formula (1).

Pout=(Fsol+Fsp)/(π×D×D/4) (1)

In the formula (1), Pout (MPa) represents the pressure of the gas fuel supplied to the gas fuel injector 24 by the second pressure reducing valve 50, Fsol (N) represents an electromagnetic attracting force generated by the electromagnetic drive part 70, Fsp (N) represents a set load of the second valve-opening-side spring 57, and D (mm) represents an effective diameter of the diaphragm 55. Thus, the load applied to the needle 53 by the electromagnetic drive part 70 can be changed by the electromagnetic attracting force generated by the electromagnetic drive part 70, that is, the command current value passed through the coil 75.

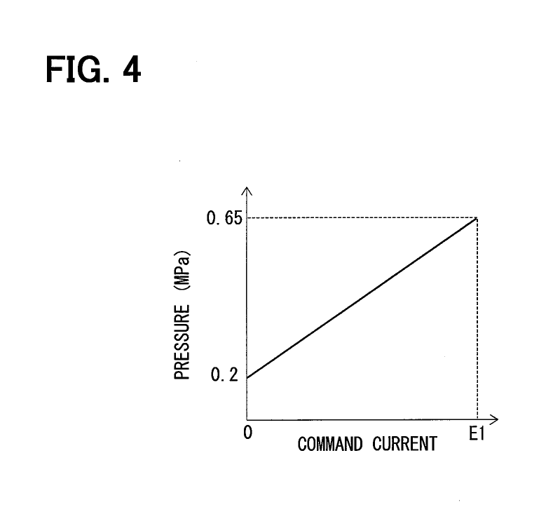

A relationship between the magnitude of the command current outputted to the electromagnetic drive part 70 and the pressure of the gas fuel supplied to the gas fuel injector 24 by the second pressure reducing valve 50 will be shown in FIG. 4. When the command current is “0”, the electromagnetic attracting force is not generated in the electromagnetic drive part 70. Only the set load Fsp of the second valve-opening-side spring 57 is applied to the needle 53. Hence, the pressure Pout of the gas fuel supplied to the gas fuel injector 24 by the second pressure reducing valve 50 becomes a value acquired by dividing the set load Fsp of the second valve-opening-side spring 57 by an effective area of the second diaphragm 55, as shown by the formula (1). In the present embodiment, as shown in FIG. 4, the pressure Pout of the gas fuel supplied to the gas fuel injector 24 by the second pressure reducing valve 50 becomes, for example, 0.2 MPa.

When the command current outputted to the electromagnetic drive part 70 is made larger than “0”, as shown in FIG. 4, the pressure Pout of the gas fuel supplied to the gas fuel injector 24 by the second pressure reducing valve 50 becomes larger. At this time, the pressure Pout of the gas fuel supplied to the gas fuel injector 24 by the second pressure reducing valve 50 becomes a value acquired by dividing a value, which is acquired by adding the electromagnetic attracting force Fsol generated by the electromagnetic drive part 70 to the set load Fsp of the second valve-opening-side spring 57, by the effective area of the second diaphragm 55 according to the formula (1). As shown in FIG. 4, in a case where a maximum current E1 is passed through the coil 75, the pressure of the gas fuel supplied to the gas fuel injector 24 by the second pressure reducing valve 50 becomes, for example, a maximum value of 0.65 MPa.

In this way, the second pressure reducing valve 50 can change the pressure of the gas fuel supplied to the gas fuel injector 24 according to the magnitude of the command current outputted to the electromagnetic drive part 70. Hence, the pressure of the gas fuel in the region “C” of the second middle-pressure chamber 511 is as large as 1.4 MPa which is equal to the region “B” of the first middle-pressure chamber 321. The pressure of the gas fuel in the region “D” of the low-pressure chamber 521 can be arbitrarily set at 0.2 to 0.65 MPa by the second pressure reducing valve 50.

In the second pressure reducing valve 50, in a case where the tapered face 535 of the valve portion 533 is separated from the second seat face 612 of the second valve seat 61, the gas fuel flowing into the second middle-pressure chamber 511 passes through the through-hole 611 of the second valve seat 61, the through-hole 601 of the valve seat holder 60, and the communication passage 603. Then, the gas fuel flows into the annular apace 604. Further, the gas fuel flowing into the annular space 604 passes through the communication passage 523 and flows into the low-pressure chamber 521. At this time, the pressure of the low-pressure gas fuel existing in the low-pressure chamber 521 is equal to Pout in the formula (1). In a case where Pout becomes larger than a value on the right-hand side of the formula (1), the diaphragm cover 551, the cylindrical part 552, the spring holder 64, and the second coupling part 59 are moved in the lower direction in FIG. 2. In this way, the tapered face 535 abuts on the second seat face 612.

When the gas fuel in the annular space 604 and in the low-pressure chamber 521 is supplied to the gas fuel injector 24 via the flow passage 283 and the supply pipe 8, the pressure of the gas fuel in the annular space 604 and in the low-pressure chamber 521 is decreased. When the pressure of the gas fuel in the low-pressure chamber 521 is decreased, the pressure applied to the upper face of the diaphragm cover 551 becomes smaller, so that the tapered face 535 is separated from the second seat face 612 of the second valve seat 61 by the load applied by the second valve-opening-side spring 57 and by the load applied by the electromagnetic drive part 70. In this way, the gas fuel flows into the low-pressure chamber 521 from the second middle-pressure chamber 511.

Further, the low-pressure gas fuel flowing into the annular space 604 passes through the cutout of the valve seat holder 60, the annular flow passage 513 of the second middle-pressure-chamber-forming part 51, the annular flow passage 625 of the spring engaging part 62, the annular space 651 of the cylindrical part 65, and the communication passage 632 of the second pressure-chamber-forming part 63. Then, the low-pressure gas fuel flows into the second pressure chamber 631. In this way, the pressure of the gas fuel in the annular space 604 becomes equal to the pressure of the gas fuel in the second pressure chamber 631. The end portion of the large-diameter portion 534 protruding into the second pressure chamber 631 is formed in such a way as to have an area equal to an area in which the tapered face 535 of the valve portion 533 abuts on the second seat face 612, so that the load applied to the needle 53 by the pressure of the gas fuel in the second middle-pressure chamber 511 is cancelled.

The gas fuel having pressure reduced to a specified low pressure by the second pressure reducing valve 50 is passed through the supply pipe 8 and is supplied to the gas fuel injector 24.

The regulator 1 of the present embodiment reduces the pressure of the high-pressure gas fuel in two steps by the first pressure reducing valve 30 and by the second pressure reducing valve 50. The pressure of the high-pressure gas fuel is reduced to a provisional middle pressure by the first pressure reducing valve 30, so that the second O-ring 54 responding to a small pressure difference of from a middle pressure to a low pressure can be used in the second pressure reducing valve 50. The second pressure reducing valve 50 is capable of changing the pressure of the gas fuel within a specified range. In this way, a sealing part having a resistive force used by a gas fuel pressure control device in the related art is not required. Further, the second O-ring 54 does not have the large resistive force and hence the sliding resistance of the needle 53 to the second O-ring 54 can be reduced. In this way, the electromagnetic attracting force generated by the electromagnetic drive part 70 can be made smaller. Hence, the size of the regulator 1 can be reduced and the electricity consumed by the electromagnetic drive part 70 can be reduced. The pressure of the gas fuel supplied to the gas fuel injector 24 can be changed.

Further, the second pressure reducing valve 50 does not need a pilot gas fuel rate at the time of controlling the pressure of the gas fuel, which is different from a pilot valve used by the gas fuel pressure control device in the related art. In this way, the flow rate of the gas fuel during an idling operation in which only an extremely small amount of gas fuel is required is not changed by the pilot flow rate. Hence, because an extremely small amount of gas fuel required during the idling operation can be supplied and the amount of gas fuel supplied to the engine 26 is not affected by the pilot flow rate, the second pressure reducing valve 50 can be improved in responsiveness.

Still further, in a gas fuel supply system using the gas fuel pressure control device in the related art, in a case where a drive part for controlling the pressure of the gas fuel is damaged, the gas fuel pressure control device is brought into a fully opened state or a totally closed state and hence cannot adjust the pressure of the high-pressure gas fuel, which results in making it impossible to drive the vehicle. In the regulator 1 of the present embodiment, even in a case where the electromagnetic drive part 70 in the second pressure reducing valve 50 for controlling the pressure of the gas fuel supplied to the gas fuel injector 24 is damaged, the set load of the second valve-opening-side spring 57 is applied to the needle 53, so that the gas fuel having a pressure of 0.2 MPa can be supplied. Thus, even in a case where the electromagnetic drive part 70 is damaged, the vehicle can travel.

Still further, in a case where the pressure of the gas fuel supplied by the second pressure reducing valve 50 is changed by the load applied by the electromagnetic attracting force generated by the electromagnetic drive part 70, the coil 75 is energized in a short cycle. In this way, the movable core 72 and the needle 53 cooperatively moved by the movement of the movable core 72 are vibrated little by little for the second O-ring 54. When the movable core 72 and the needle 53 are vibrated little by little for the O-ring 54, the sliding resistance between the needle 53 and the second O-ring 54 becomes smaller and hence a load can be applied to the needle 53 by a comparatively small electromagnetic attracting force. Hence, the electromagnetic drive part 70 can be reduced in size and hence the regulator 1 can be further reduced in size.

The electromagnetic drive part 70 has two fixed cores for one movable core 72. When the current is passed through the coil 75, the movable core 72 is moved by the electromagnetic attracting forces of a first fixed core 73 and a second fixed core 74. In this way, the electromagnetic drive part 70 can move the movable core 72 by a small amount of electricity. Hence, the electricity consumed by the regulator 1 can be further reduced.

### Other Embodiments

(A) In the embodiment described above, the regulator is applied to the gas fuel supply system mounted in the vehicle. However, a system to which the regulator is applied is not limited to this. The regulator is acceptable as long as it can be mounted with an internal combustion engine of using the gas fuel as fuel.

(B) In the embodiment described above, when the command current is increased as shown in FIG. 4, the pressure of the gas fuel supplied by the second pressure reducing valve is increased. However, the relationship between the command current and the pressure of the gas fuel supplied by the second pressure reducing valve is not limited to this. When the command current is increased, the pressure of the gas fuel supplied by the second pressure reducing valve may be decreased. In this case, the pressure of the gas fuel supplied by the second pressure reducing valve of when the load adjusting part is damaged becomes a maximum valve to be supplied by the second pressure reducing valve, for example, 0.65 MPa.

(C) In the embodiment described above, the load adjusting part applies the load by the generated electromagnetic attracting force in a direction in which the tapered face of the valve portion is separated from the second seat face of the second valve seat in the second pressure reducing valve. However, a direction in which the load adjusting part applies the load is not limited to this. The load adjusting part may apply the load in a direction in which the tapered face of the valve portion abuts on the second seat face of the second valve seat in the second pressure reducing valve.

(D) In the embodiment described above, the area of the end portion of the large-diameter portion of the needle included by the first pressure reducing valve is equal to an area in which the tapered face abuts on the first seat face. Further, the area of the end portion of the large-diameter portion of the needle included by the second pressure reducing valve is equal to an area in which the tapered face abuts on the second seat face. However, the relationship between the area of the end portion of the large-diameter portion and the area in which the tapered face abuts on the seat face is not limited to this.

(E) In the embodiment described above, the space in which the second valve-opening-side spring is housed communicates with the atmosphere through the communication passage formed in the second valve body. However, a space communicating with the space in which the second valve-opening-side spring is housed is not limited to this but may communicate with the interior of the intake pipe.

(F) In the embodiment described above, the load adjusting part is a linear solenoid. However, the load adjusting part is not limited to this. The load adjusting part has only to be a load adjusting part capable of adjusting the load applied to the needle of the second pressure reducing valve independently of the second valve-opening-side spring.

(G) In the embodiment described above, the minimum value of the command current passing through the coil is “0”. However, the minimum value of the command current is not limited to this.

(H) In the embodiment described above, the “third seal part” is the diaphragm. However, the “third seal part” is not limited to this. In place of the diaphragm, an O-ring may be used

(I) In the embodiment described above, the “first seal part” is the O-ring. However, the “first seal part” is not limited to this. In place of the O-ring, a diaphragm may be used as the “first seal part”.

(J) In the embodiment described above, the second valve-opening-side spring is the coil spring. However, the second valve-opening-side spring is not limited to this. The second valve-opening-side spring has only to be an elastic body capable of applying a load to the needle.

(K) In the embodiment described above, the regulator has the electromagnetic shutoff valve disposed on the upstream side of the first pressure reducing valve. However, the regulator does not need to have the electromagnetic shutoff valve disposed therein.

As described above, the present invention is not limited to these embodiments but can be carried out in various modes within a scope not departing from the gist of the invention.

What is claimed is:

1. A gas fuel pressure control device used for a gas fuel supply system for controlling pressure of a gas fuel stored in a fuel tank and for supplying the gas fuel to an internal combustion engine via an injection portion, the gas fuel pressure control device comprising:
a first pressure control portion for reducing the pressure of the gas fuel in the fuel tank to a first pressure;
a second pressure control portion for reducing the pressure of the gas fuel reduced by the first pressure control portion to a second pressure at which the injection portion can inject the gas fuel and which is smaller than the first pressure; and
a pressure value changing portion which is provided in the second pressure control portion and which can change a value of the second pressure to which the pressure of the gas fuel is reduced by the second pressure control portion.

2. The gas fuel pressure control device according to claim 1, wherein
the second pressure control portion includes:
a second main valve body having a second valve seat formed thereon;
a second communication passage defined in the second main valve body and communicating with the first pressure control portion;
a discharge passage defined in the second main valve body and communicating with the injection portion;
a second valve part which is housed in the second main valve body in such a way as to be reciprocally moved and which abuts on or separates from the second valve seat to thereby shut off the second communication passage from the discharge passage or to thereby make the second communication passage communicate with the discharge passage;
a second seal part interposed between an outer wall of one end of the second valve part and an inner wall of the second main valve body;
a third seal part which is interposed between an outer wall of the other end of the second valve part and the inner wall of the second main valve body and which is disposed in such a way that the pressure of the gas fuel in the discharge passage is applied to the second valve part; and
a load applying portion for applying a load in a direction, which is opposite to a direction of a load by the pressure of the gas fuel in the discharge passage to which the second valve part is subjected, to the second valve part, and
wherein the pressure value changing portion changes a balance between the load applied to the second valve part by the pressure of the gas fuel in the discharge passage and the load applied to the second valve part by the load applying portion to thereby change a value of the second pressure of the gas fuel.

3. The gas fuel pressure control device according to claim 2, wherein
the load applying portion is provided with a load adjusting portion capable of changing a load applied to the second valve part.

4. The gas fuel pressure control device according to claim 3, wherein
the pressure value changing portion can change a load applied to the second valve part independently of the load adjusting portion.

5. The gas fuel pressure control device according to claim 2, wherein
the pressure value changing portion changes the load applied to the second valve part by an electromagnetic force generated when current is passed.

6. The gas fuel pressure control device according to claim 5, wherein
when the current is not passed, the electromagnetic force generated by the pressure value changing portion becomes zero.

7. The gas fuel pressure control device according to claim 6, wherein
when the electromagnetic force generated by the pressure value changing portion becomes zero, the second pressure control portion changes the pressure of the gas fuel supplied to the injection portion to a minimum pressure.

8. The gas fuel pressure control device according to claim 2, wherein
the third seal part seals between the discharge passage and the atmosphere or between the discharge passage and an intake pipe of the internal combustion engine.

9. The gas fuel pressure control device according to claim 2, wherein
the third seal part is a diaphragm or an O-ring.

10. The gas fuel pressure control device according to claim 2, wherein
the second seal part seals between the second communication passage and the discharge passage.

11. The gas fuel pressure control device according to claim 2, wherein
the second seal part is a diaphragm or an O-ring.

12. The gas fuel pressure control device according to claim 2, wherein
a pressure receiving area on a second communication passage side of the second seal part is equal to a pressure receiving area on the second communication passage side of the second valve part.

13. The gas fuel pressure control device according to claim 2, wherein
the pressure value changing portion changes the load while it is vibrated cyclically.

14. The gas fuel pressure control device according to claim 1, wherein
the first pressure control portion includes:
a first main valve body having a first valve seat formed thereon;
a supply passage defined in the first main valve body and communicating with the fuel tank;
a first communication passage defined in the first main valve body and communicating with the second pressure control portion;
a first valve part which is housed in the first main valve body in such a way as to be reciprocally moved and which abuts on or separates from the first valve seat to thereby shut off the supply passage from the first communication passage or to thereby make the supply passage communicate with the first communication passage; and
a first seal part which is interposed between an outer wall of one end of the first valve part and an inner wall of the first main valve body and which seals the supply passage and the first communication passage, and
wherein a pressure receiving area on the first communication passage side of the first seal part is equal to a pressure receiving area on the first communication passage side of the first valve part.

15. The gas fuel pressure control device according to claim 1, wherein
the first pressure control portion has an electromagnetic shutoff valve disposed on an upstream side thereof.
